(19) United States
(12) Patent Application Publication
(10) Pub. No.: US 2021/0150374 A1
(43) Pub. Date: May 20, 2021

(54) COMMUNICATION MANAGEMENT

(71) Applicant: International Business Machines Corporation, Armonk, NY (US)

(72) Inventors: Paul R. Bastide, Ashland, MA (US); Robert E. Loredo, North Miami Beach, FL (US); Matthew E. Broomhall, Goffstown, NH (US)

(21) Appl. No.: 16/689,364

(22) Filed: Nov. 20, 2019

(51) Int. Cl. G06N 5/02; G06Q 10/10; H04L 12/58; H04L 29/08

(52) U.S. Cl. CPC G06N 5/02; H04L 67/141; H04L 51/22; G06Q 10/107

(57) ABSTRACT

Communication between a plurality of users is monitored for a first period of time. A model of the communication between the user for the first period of time is generated. Respective baselines of communication for each user of the plurality of users are established based on the model. Each of the respective baselines includes a respective range of probabilistic outcomes. Communication that is outside of a range of a baseline for a user of the plurality of users is detected over a second period of time. A remedial action that is configured to bring communication of the user within the range of the baseline for the user is executed.

### BACKGROUND

There are an increasing number of communication methods being used by organizations for users to communicate. For example, in addition to email, organizations increasingly rely on or otherwise utilize social network communication, chatting applications, online posting boards, or the like. Further, even the use of email is growing in magnitude as mobile devices allow users to receive and send email nearly anywhere at any time. These assorted communication mechanisms enable users to rapidly share a wealth of information to a multitude of other users, enabling each user of an organization to rapidly disperse information in a plurality of directions.

### SUMMARY

Aspects of the present disclosure relate to a method, system, and computer program product relating to communication management. For example, the method may include monitoring communication between a plurality of users for a first period of time. The method may further include generating a model of the communication between the plurality of users for the first period of time. The method may further include establishing respective baselines of communication for each of the plurality of users based on the model. Each of the respective baselines includes a respective range of probabilistic outcomes. The method may further include detecting, over a second period of time, communication that is outside of a range of a baseline for a user of the plurality of users. The method may further include executing a remedial action that is configured to bring communication of the user within the range of the baseline for the user. A system and computer product configured to perform the above method are also disclosed.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1A depicts a conceptual diagram of an example system in which a controller may manage communication between a plurality of users.

FIG. 1B depicts communication between users.

FIG. 2 depicts a conceptual box diagram of example components of the controller of FIG. 1A.

FIG. 3 depicts an example flowchart by which the controller of FIG. 1A may manage the communication between a plurality of users.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to managing communication, while more particular aspects of the present disclosure relate to identifying baselines of communication for a plurality of users and executing remedial actions when communication is outside of those baselines. While the present disclosure is not necessarily limited to such applications, various aspects of the disclosure may be appreciated through a discussion of various examples using this context.

An organization (such as a company) may include a number of members or “users,” wherein each user may utilize a plurality of communication methods to communicate. Examples of these communication methods include email, chatting applications, message boards, audio/video telecommunication meetings, or the like. Many of these communication methods allow one-to-many messages (e.g., where one user sends a single message to many users), such that it may be difficult or impossible for any given user to monitor or track all messages being transmitted across the organization. For many users, a primary and/or exclusive concern is being able to identify which messages may be functionally ignored such that a number of relevant messages is reduced to a manageable number.

Towards this end, users may utilize one or more conventional computing systems that are configured to manage communication by reducing a number of messages that require attention. These conventional solutions may include a spam reduction program that is configured to identify and/or delete unwanted and/or unnecessary messages (e.g., such as spam, marketing materials, or the like). Other conventional solutions may be configured to highlight and/or summarize messages, so as to draw a user's attention to those message that the solution identifies as being relatively more worthy of attention. Yet another conventional solution may attempt to condense messages by de-duplicating messages that have identical or similar content.

However, in some examples an organization may suffer from users receiving too little communication, and/or by having users receive a suboptimal array of communication. For example, a user may operate at peak efficiency when the user is receiving and/or processing a few hundred messages a day (e.g., a hundred emails, a hundred chatting application messages, a handful of social media posts to respective profile of the user), such that this user is underutilized and/or less efficient if this user starts to receive only a few dozen messages a day. Additionally, or alternatively, some users may be a valuable resource for many projects, departments, clients, or the like, such that if communication changes such that these users are only utilized by a single project/department/client that the user (and/or the project/department/client) may suffer as a result. The conventional communication management solutions described above may not track such trends, such that it may be difficult or impossible for a user to utilize these conventional solutions to solve these issues.

Aspects of the disclosure may improve or solve these shortcomings. For example, aspects of this disclosure relate to identifying baselines of communication for a plurality of users, and therein executing remedial actions in response to detecting that communication is outside calculated bounds of this baseline. A computing system that includes a processor that executes instructions stored on a memory (this computing system hereinafter referred to as a controller) may monitor communication of an organization to identify these baselines and accordingly execute remedial actions as described herein. This controller may be integrated into and/or otherwise control some functionality of one or more of the communication methods described herein.

The controller may be configured to determine if a user is receiving a suboptimal number and/or selection of messages. For example, the controller may generate a model of the communication that includes (and reflects) all users and topics of the communication. Using this model, the controller may analyze trends of message recipients and senders, as well as message content, to establish communication baselines and to then monitor and verify that users are getting messages that are consistent with their baselines. When the controller detects that a user is not getting a type and/or number of messages that is consistent with their baseline, the controller may use the model to identify which of a plurality of remedial actions may be best suited to help fix this inefficiency. As used herein, a remedial action may be an action that, according to the model of communication, is configured to bring communication towards the desired baselines. The remedial action may be the action that is determined via simulations of the model. The remedial action may include rerouting communication, generating new communication, identifying and/or facilitating social interaction to promote improved communication, and/or identifying organization changes that may promote improved communication. A controller may execute the remedial action by providing the remedial action for a user (e.g., highlighting some messages that a first user may forward to a second user to alter communication for the organization) to implement. Alternatively, or additionally, the controller may execute the remedial action by autonomously executing the action without human approval. For example, the controller may execute a remedial action automatically on a schedule (e.g., executing remedial actions once every twenty minutes), immediately upon identifying the remedial action, on a fixed delay after the remedial action (e.g., one hour after detecting a remedial action, therein checking to verify that this remedial action is not executed by a human), or the like.

As described herein, the controller may simulate each of a plurality of remedial actions using the model, checking which does the best job of re-engaging the users as desired. Each of these remedial actions may be configured to bring the communication back within the baseline. Once the controller identifies a remedial action that, according to the simulation, brings the communication back within the baseline, the controller executes that remedial actions. For example, the controller may recommend that other users reroute one or more messages to bring the communication back within the baseline, or the controller may recommend that one or more messages be created to re-engage a user (or the controller may autonomously reroute and/or create these messages itself). In this way, aspects of the disclosure may be configured to improve an ability of a computing system to identify when communication throughout an organization is suboptimal and execute a remedial action accordingly.

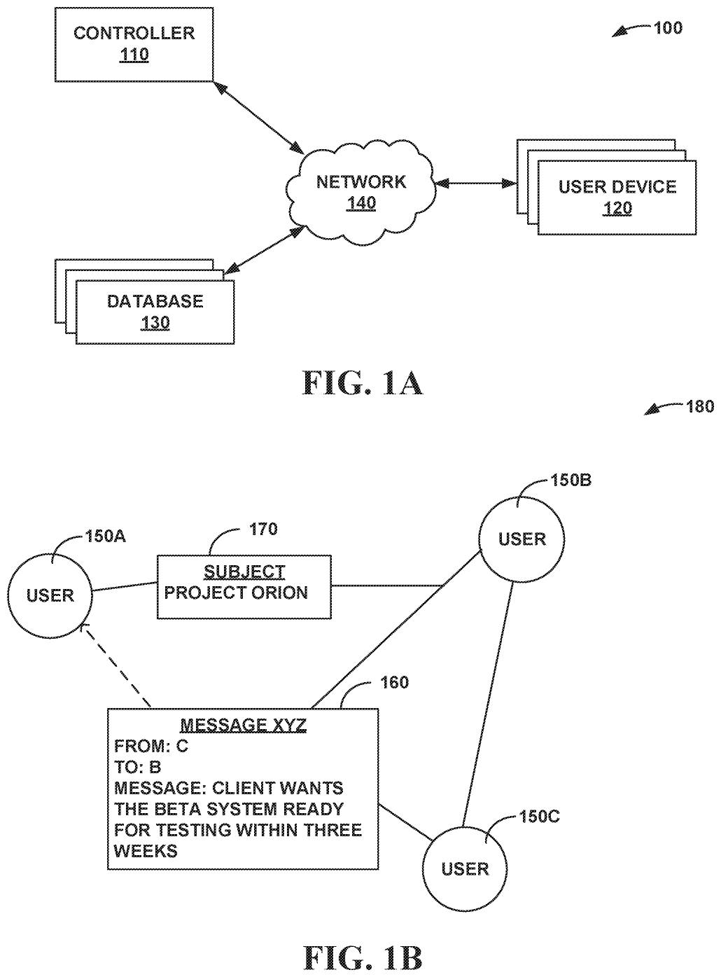

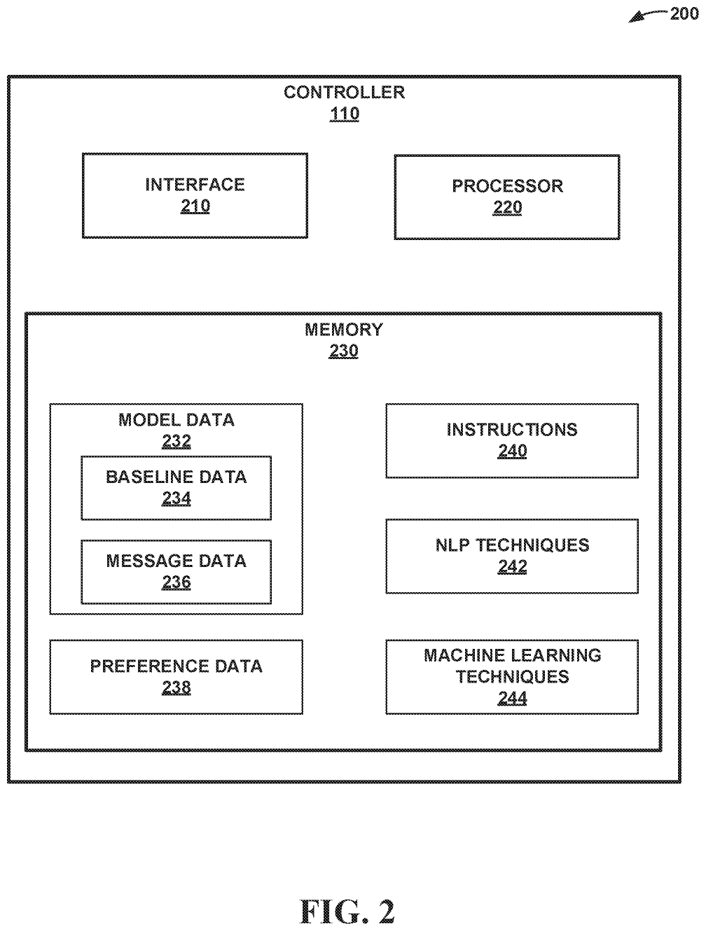

For example, FIG. 1A depicts system 100 in which controller 110 manages communication between a plurality of users. Controller 110 may include a computing device, such as computing device 200 of FIG. 2 that includes a processor communicatively coupled to a memory that includes instructions that, when executed by the processor, causes controller 110 to execute one or more operations described below. Controller 110 may manage communication between users as sent from a plurality of user devices 120. User devices 120 may include computing devices (e.g., devices similar to computing device 200 of FIG. 2) such as desktop computer, laptops, mobile phones, tablets, or the like.

Communication from user devices 120 may be sent and/or received via one or more communication methods, such as chatting applications, email applications, social media network posts, or the like. In some examples, one or more of these communication methods may be hosted on controller 110 (and therein accessed by respective user devices 120). In other examples, respective instances of the relevant communication methods may be downloaded onto user devices 120 which further download some or all functionality of controller 110 as a plugin. When downloaded as a plugin, controller 110 may manage communication for each individual instance on each respective user device 120, communicating back with the central controller 110 as necessary to stay consistent across the organization. In other examples, each communication method may be hosted on separate computing devices (such as on different servers or the like), such that both controller 110 and user devices 120 access these communication methods via network 140.

Network 140 may include a computing network over which computing messages may be sent and/or received. For example, network 140 may include the Internet, a local area network (LAN), a wide area network (WAN), a wireless network such as a wireless LAN (WLAN), or the like. Network 140 may comprise copper transmission cables, optical transmission fibers, wireless transmission, routers, firewalls, switches, gateway computers and/or edge servers. A network adapter card or network interface in each computing/processing device (e.g., controller 110, user devices 120, and or databases 130) may receive messages and/or instructions from and/or through network 140 and forward the messages and/or instructions for storage or execution or the like to a respective memory or processor of the respective computing/processing device. Though network 140 is depicted as a single entity in FIG. 1A for purposes of illustration, in other examples network 140 may include a plurality of private and/or public networks.

Controller 110 may monitor a conversation between a plurality of users communicating via user devices 120. Though it is discussed herein as if each user is related to a single respective user device 120, in other examples, multiple users may relate to a single user device 120, and/or some users may relate to multiple user device 120. Controller 110 monitors communication across network between user devices 120. Controller 110 may create a model of communication that tracks and accounts for each user, message, and topic of communication across network 140. For example, controller 110 may create an organization chart where entities that controller 110 wants to track are unique nodes. For example, each user may be a unique node, while each message is a unique node, and each subject is a unique node (e.g., where a subject may be a project, a client, a department, or the like), where all nodes are connected by edges that reflect the ongoing communication. Other organizational structures that reflect the communication are also possible.

Once the communication is monitored and an organizational structure (such as a model) is created, controller 110 may identify a baseline of communication for each user. As discussed herein, a baseline of communication includes an average amount and type of communication that can be expected for a given user. In some examples, controller 110 may identify baselines that can be expected to be relatively stable across healthy organizations, such that a deviation from these baselines indicates inefficiencies. As such, controller 110 may identify baselines over a period of time that are determined to eliminate most or all noise that is inherent in human environments.

Put differently, controller 110 may monitor communication for a period of time that is sufficient to identify statistically indicative baselines for some, most, or substantially all users. For example, in order to identify baselines, controller 110 may monitor communication for a month, two months, three months, a year, or the like. In this way, controller 110 may be configured to monitor communication for a period of time that is sufficient to be statistically significant, such that a “randomly” high or low rate of communication on a given hour, day, week, or the like will not result in controller 110 identifying a non-indicative baseline.

As discussed herein, a baseline may indicate a number of factors of communication for a user. For example, the baseline may indicate an average number of messages that a user will receive per day, per week, per month, or the like. The baseline may also indicate an average number of messages that a user will receive regarding different subjects, such as an average number of messages regarding a project, a client, or the like. Controller 110 may also identify baselines such that they identify an average number of sources of messages, such as an average number of messages from respective users, departments, or the like. For example, controller 110 may identify that a baseline includes an average number of messages from one predetermined user to another (set of) predetermined user(s).

In some examples, controller 110 may identify baselines such that they are unique to each user. In other examples, controller 110 may identify baselines such that they are relative to positions or roles within the organization. In other examples, controller 110 may merge the two together based on other factors, such as a seniority of users within a role, where each user starts with a baseline that is relative to their job, and this baseline may, e.g., become more robust if their seniority level indicates a relatively more senior user. Controller 110 may access one or more databases 130 of network to identify such factors as a seniority that may otherwise impact a user's baseline as identified by controller 110.

In some examples, controller 110 may identify a baseline for each mode of communication, such that there is a first baseline for email, a second baseline for a first chatting application, a third baseline for a second chatting application, or the like. In other examples, controller 110 may identify one or more baselines that reflect communication across a plurality of different communication methods. For example, controller 110 may identify a baseline for a user that includes messages that relate to a first project, regardless as to whether these messages come via a chatting application, email platform, social media profile, or the like.

In identifying these baselines, controller 110 may further identify a range of communication activities that are calculated to be normal and/or “efficient” communication. Controller 110 may execute one or more probabilistic functions to determine these ranges. Controller 110 may compare the communication received by one user to communication received by other users to determine this range. For example, controller 110 may compare communication received by one user with a first role to communication received by other users with similar roles to establish this range.

Once controller 110 identifies these baselines, controller 110 may monitor for communication outside of these baselines. For example, controller 110 may identify that a user that has a baseline of receiving 750 emails a day with a range of plus or minus 150 emails, and that this user has received 400 emails for a week. However, controller 110 may be configured to execute a remedial action once monitored communication is outside of the range of the baseline for longer than a threshold period of time, such that upon first detecting this, controller 110 may continue to monitor (e.g., continue to monitor until there is relatively more certainty that the out-of-range communication indicates an inefficiency rather than a statistical anomaly that will soon revert back).

For example, the threshold period of time may be two weeks, three weeks, a month, or the like, such that controller 110 is configured to execute a remedial action once detected communication is outside the range (on average) from the baseline for this entire threshold period. As such, controller 110 may continue monitoring the above communication, therein identifying received 605 emails a week for the next three weeks, such that for a month (which may be the threshold period of time) the user is averaging 553.75 emails a week, which is well below the range to the baseline (even though three weeks of the month were barely within the range). In other examples, controller 110 may utilize other analyses to determine an amount of communication received by the user, such as identifying a mode or median number of messages, both of which might cause controller 110 to determine that communication is within range of the baseline (such that the monitored communication is sufficient and does not warrant a remedial action).

If controller 110 determines that communication is outside of the range of the baseline, controller 110 may run a plurality of simulations on the model to test which of a number of remedial actions may improve the communication. Controller 110 may identify that a remedial action improves the communication if the remedial action causes the communication to move towards the baseline and eventually results in the communication being within the identified baseline.

For example, in the situation above, controller 110 run simulations of the model in which one or more messages are directed to different users. For example, in response to identifying that the underutilized user above is receiving less than the range of the baseline, controller 110 may run a simulation in which an admin user and/or controller 110 caused some messages to be directed to the underutilized user. Controller 110 may simulate controller 110 autonomously directing messages to the user, such as by forwarding or carbon copying (ccing) the user on messages that otherwise relate to the user. Additionally, controller 110 may simulate directing other users to direct messages to the underutilized user. For example, after identifying that a user is underutilized, and further identifying that a message may be sent to this user, controller 110 may simulate providing a directive to the sender and/or the recipient of a message requesting that this sender and/or recipient forward the message to the user.

In certain examples, controller 110 may simulate a remedial action of generating a report for one or more users. This report may be generated for the underutilized user, a boss of the underutilized user, other users that are underutilizing the underutilized user, or the like. In some examples, controller 110 may regularly generate these reports on a timed basis to one or more qualified users.

In other examples, as part of these simulations controller 110 may identify that the deviation from the baseline is more substantial and/or systemic, such that a plurality of users are all communicating in a suboptimal way. In such examples, controller 110 may identify one or more users that are contributing relatively more than other users, such that these users may be flagged as needing a role transition. For example, through these simulations controller 110 may identify that some users have been involved with deviations from the identified baselines in a number of different roles and/or with a number of different groups. Additionally, or alternatively, controller 110 may simulate that new people have gained new roles (e.g., by being hired or promoted), to identify whether or not this improves or worsens communication trends. For example, through simulations controller 110 may identify that a current user in a role communicates with each of 8 users, while a different user that is not currently in this role might communicate with each of these original 8 users as well as another 7 users that would be better utilized via this different user. As such, controller 110 may identify that this different user should be given this role, and/or controller 110 may identify that the current user in this role may benefit from a social event which may be helpful to increase connectivity with this current user and the additional 7 users (that are currently being underutilized).

For another example, in response to determining that communication of a user has dropped a range below a baseline as a result of this user not communicating regarding projects A, B, and C, controller 110 may isolate increased involvement with project D as the cause of this issue. For example, controller 110 may determine this by simulating the model for different remedial actions, and identifying that probabilistic scenarios as executed by controller 110 identified that the user only renewed communication regarding projects A, B, and C following less communication regarding project D. As such, controller 110 may provide a remedial action of suggesting that this user transition from project D (to help more with projects A, B, and C), and/or controller 110 may suggest that some communication on project D be diverted away to other users (such that the underutilized user may spend more time on projects A, B, and C).

Upon identifying the appropriate remedial action, controller 110 may execute this remedial action that is configured to cause the communication to move towards the baseline and eventually be within the identified baseline.

Controller 110 may store each baseline and associated range in databases 130. In some examples, controller 110 may update these baselines and/or ranges over time based on changing communication trends across network 140. Further, in other examples controller 110 may learn (using machine learning techniques as described herein) how to better identify baselines and/or execute remedial actions over time.

For example, controller 110 may identify whether or not remedial actions tend to drive communication back towards identified baselines. Where controller 110 identifies that some remedial actions drive communication back towards baselines, controller 110 may reinforce the rules that lead to controller 110 executing those remedial actions. For example, if controller 110 identifies that requesting that a user forward a message to an underutilized user leads to a utilization of this user being closer to the baseline, controller 110 may reinforce the techniques that caused controller 110 to provide this remedial action request.

Alternatively, or additionally, controller 110 may learn via express feedback from one or more users. For example, if controller 110 suggests that a user forward a message, after which this user does not forward the message, controller 110 may weaken a rule that caused controller 110 to suggest this forwarding. Similarly, controller 110 may include an option for one or more users of an action to indicate approval or disapproval of a suggested remedial action received by these users. Where users approve, controller 110 may reinforce the rule that cause controller 110 to suggest this action, and where users disapprove controller 110 may alternately weaken or remove the rule.

For example, FIG. 1B depicts an example communication chart 180 that may be generated and/or maintained by controller 110. As depicted, communication chart 180 includes users 150A-150C (collectively, “users 150”). Controller 110 may monitor network 140 for messages using a push/pull feed. This push/pull feed may be triggered by messaging/topic notification or the like. In some examples, controller 110 may begin by creating a communication chart of substantially all communication of an organization.

Controller 110 may gather all of this data and execute a de-duplicating process to ensure that only a single message is used for each communication event. In order to determine all nodes for communication chart 180, controller 110 may gather data such as a full list of users and their roles within the organization (e.g., gather this data from database 130 or the like). In some examples, controller 110 may only gather communication data as described herein following controller 110 acquiring an opt-in from certain admin users and/or from substantially all users in the organization.

Controller 110 may identify and note (within communication chart 180) a plurality of fields from each message, such as a “to” field, a “cc” field, a “bcc” field, a body field, or the like. In some examples, controller 110 may further identify all metadata within each message as well, such as reply-marks, read-marks, gaze data, or the like. In identifying communication when creating communication chart 180, controller 110 may be configured to identify a central idea of messages, ignoring (or taking less consideration of) tangential elements of the messages. Controller 110 may use NLP techniques as discussed herein to identify the most relevant aspects of messages, such as a portion of a message that indicates action items or lists that it is a “MUST READ” portion or the like.

Once all of this data is extracted, controller 110 may utilize this data to create organizational communication chart 180 that includes substantially all of the communication data. Communication chart 180 may comprise a plurality of nodes and edges that reflect all of the gathered data. For example, each message may be a node such as message 160. These message nodes may include a unique message identifier for each respective message (e.g., such as a composite key of a concatenation of conversation message identifiers). These message nodes may be annotated with the time that the message was read, received, and/or sent. Controller 110 may be configured to create communication chart 180 such that it reflects bi-directional communication (e.g., both to and from fields of communication, where appropriate). Controller 110 may also create a node for each subject of a message (e.g., such as subject node 170), such that subjects may be independently tracked and analyzed. Edges (e.g., the lines of communication chart 180) may link topics within each message. Each user may also have a unique node (e.g., such as nodes 150A, 150B, 150C). Such nodes may have a unique identifier such as their email address.

Once organizational chart 180 is created, controller 110 may analyze organizational chart 180 to identify the baselines as discussed herein. For example, controller 110 may analyze communication of a different time chunks, such as a three-month segment with, e.g., one-month overlaps. Controller 110 may utilize an overlap to normalize the data. Controller 110 may put this data into segments going back a period of time, such as number of years (e.g., three years), a duration equivalent to job turnover, a number of business quarters, or the like. These data segments may be used to establish the baseline between various concepts by analyzing the nodes and edges on various topics/projects/clients/etc.

Controller 110 may be configured to integrate or combine two or more concepts together, sometimes across different time segments, to identify comprehensive communication models across an entire organization. For example, by integrating communication patterns over different time segments together at shared concepts, controller 110 may identify how communication and productivity flows within an organization, and moreover how this flow changes to more or less efficiently utilize users. In this way, controller 110 may identify gaps within the chart where communication may not reliably flow to or reach in different situations with different variables. Additionally, or alternatively, controller 110 may identify when a user is well positioned to improve communication in a direction on a certain topic. As such, controller 110 may be configured to identify where communication should go through users, what communication roles users should have within an organization, and/or if there are any communication chokeholds that are artificially limiting the flow of communication throughout an organization.

As discussed herein, controller 110 may be configured to identify and assess changes in communication. For example, controller 110 may be configured to identify if messages include different users as they discuss different content. In some examples, controller 110 may further identify and analyze if the sentiment of communication changes, and further analyze impacts thereof.

In this way, once baselines are established controller 110 may execute a plurality of simulations and statistical analyses to “test” a plurality of remedial actions within simulations and therein identify one or more remedial actions to execute. For example, controller 110 may simulate the transition and/or turnover of some or all users to determine how a new user may impact the communication. Additionally, or alternatively, controller 110 may simulate interjected/redirected messages. Controller 110 may model these changes and/or remedial actions within different segments, therein reducing and/or increasing communication at different locations to random degrees. Eventually, controller 110 may identify remedial actions that have the best chance to bring inefficient communication back to an efficient baseline.

Controller 110 may determine that a first user 150A is underutilized as described herein. For example, controller 110 may determine that user 150A is receiving less than a lower range of a baseline of communication relating to beta system testing. Controller 110 may have determined that user 150A has a role as a programming integrator, trained to integrate software patches from one environment to another environment. Controller 110 may further identify that user 150A has previously worked with numerous projects, such as project Orion (e.g., as indicated on communication chart 180 via the edge between user 150A and the general subject project Orion). Controller 110 may have identified this role from database 130 that indicated roles and capabilities of some or all users 150. Further, controller 110 may identify that user 150A has a baseline of working with both beta environments and production environments but has been focused on production environments for the last three weeks, such that user 150A has potentially fallen out of the loop as to what has happened in beta environments.

Once this is detected, controller 110 may monitor network 140 for communication that may be used to bring user 150A closer to the respective baseline. In so doing, controller 110 may identify message 160 from user 150C to user 150B. Controller 110 detect message 160 in a format similar to:

{
“body” : {

“@context”: “http://www.w3.org/ns/activitystreams”,
“actor”: {

“id”: “http://carol.example.org”,
“name”: “User A”,
“type”: “User”

},
“timestamp”: “Friday @6:00 PM”,
“message”: “ Re: Project”

}

Controller 110 may identify different aspects of message 160, such as the recipient, the sender, and the message content, which in this case includes “client wants the beta system ready for testing within three weeks.” Controller 110 may further identify that message 160 relates to project Orion subject node 170. Controller 110 may thusly identify that message 160 is related to the baseline of user 150A that is currently below the permissible range. As such, controller 110 may execute the simulations as defined herein to identify a remedial action of redirecting message 160 to user 150A.

In some examples, controller 110 may autonomously redirect message 160, such that controller 110 sends message 160 to user 150A in addition to user 150B (e.g., such that message 160 is forwarded to user 150A). In this example, controller 110 may notify one or all users 150 of the original set of senders and recipients of this forwarding. In other examples, controller 110 may prompt one or both of users 150B, 150C to forward message 160 to user 150A.

As described above, controller 110 may include computing device 200 with a processor configured to execute instructions stored on a memory to execute the techniques described herein. For example, FIG. 2 is a conceptual box diagram of such computing device 200 of controller 110. While controller 110 is depicted as a single entity (e.g., within a single housing) for the purposes of illustration, in other examples, controller 110 may include two or more discrete physical systems (e.g., within two or more discrete housings). Controller 110 may include interfaces 210, processor 220, and memory 230. Controller 110 may include any number or amount of interface(s) 210, processor(s) 220, and/or memory(s) 230.

Controller 110 may include components that enable controller 110 to communicate with (e.g., send data to and receive and utilize data transmitted by) devices that are external to controller 110. For example, controller 110 may include interface 210 that is configured to enable controller 110 and components within controller 110 (e.g., such as processor 220) to communicate with entities external to controller 110. Specifically, interface 210 may be configured to enable components of controller 110 to communicate with user devices 120, database 130, or the like. Interface 210 may include one or more network interface cards, such as Ethernet cards, and/or any other types of interface devices that can send and receive information. Any suitable number of interfaces may be used to perform the described functions according to particular needs.

As discussed herein, controller 110 may be configured to manage communication by identifying baselines of communication for each of a plurality of users and executing remedial actions if communication moves out of range of those baselines. Controller 110 may utilize processor 220 to thusly manage communication. Processor 220 may include, for example, microprocessors, digital signal processors (DSPs), application specific integrated circuits (ASICs), field-programmable gate arrays (FPGAs), and/or equivalent discrete or integrated logic circuits. Two or more of processor 220 may be configured to work together to manage communication.

Processor 220 may manage communication as described herein according to instructions 240 stored on memory 230 of controller 110. Memory 230 may include a computer-readable storage medium or computer-readable storage device. In some examples, memory 230 may include one or more of a short-term memory or a long-term memory. Memory 230 may include, for example, random access memories (RAM), dynamic random-access memories (DRAM), static random-access memories (SRAM), magnetic hard discs, optical discs, floppy discs, flash memories, forms of electrically programmable memories (EPROM), electrically erasable and programmable memories (EEPROM), or the like. In some examples, processor 220 may manage communication as described herein according to instructions 240 of one or more applications (e.g., software applications) stored in memory 230 of controller 110.

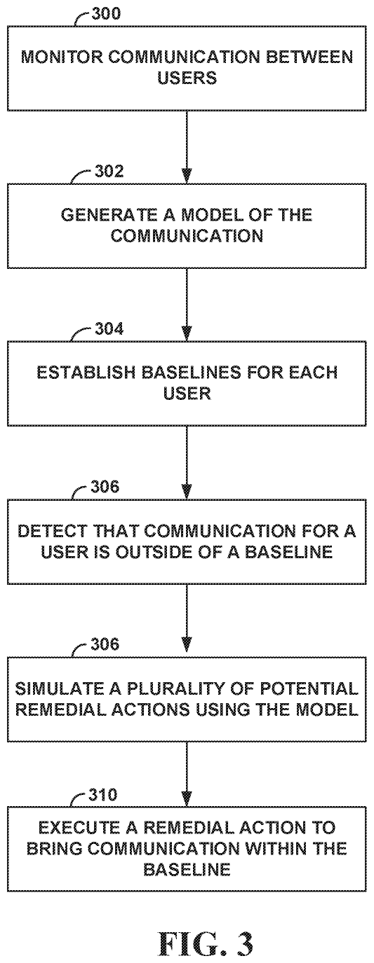

In addition to instructions 240, in some examples gathered or predetermined data or techniques or the like as used by processor 220 to manage communication as described herein may be stored within memory 230. For example, memory 230 may include information described above that may be stored in database 130, and/or may memory 230 may include substantially all of database 130. For example, as depicted in FIG. 3, memory 230 may include model data 232, which itself includes baseline data 234 and message data 236.

Model data 232 may include some or all of the data gathered by controller 110 for different communication sent via different communication means at different times. In some examples, model data 232 may include roles of users, projects associated with users, departments associated with users, or the like. Part of model data 232 may include storing some or all messages within message data 236. In some examples, controller 110 may gather and therein store within message data 236 one or more recipients of a message, a sender of a message, a topic (as applicable) of a message, the content (e.g., the body) of the message (including attachments), or the like. Further, controller 110 may store within model data 232 each of the identified baselines for respective users within baseline data 234 as described above. In some examples, as described above, model data 232 may include much of communication data as an organizational chart as described above, such that users, messages, subjects, and the like are nodes that are connected via respective edges.

In some examples, memory 230 may include preference data 238. Preference data 238 may include preferences as to how users would prefer for controller 110 to execute remedial actions. For example, controller 110 may receive a preference from user 150C from FIG. 1B following controller 110 executing a remedial action of recommending that user 150C redirect message 160 to user 150C, where the preference is that user 150C prefers that controller 110 autonomously redirects message 160 rather than request redirection. For another example, controller 110 may record within preference data 238 whether or not any users 150 would like controller 110 to ask for feedback as controller 110 offers remedial action. Some users 150 may prefer to help controller 110 improve at managing communication via machine learning techniques, whereas other users 150 may prefer to avoid being expressly involved in this training. Controller 110 may store these preferences within preference data 238.

Memory 230 may further include NLP techniques 242. NLP techniques 242 can include, but are not limited to, semantic similarity, syntactic analysis, and ontological matching. For example, in some embodiments, processor 220 may be configured to parse messages 160 across any number of communication mechanisms to determine semantic features (e.g., word meanings, repeated words, keywords, etc.) and/or syntactic features (e.g., word structure, location of semantic features in headings, title, etc.) of these messages 160. Ontological matching could be used to map semantic and/or syntactic features to a particular concept. The concept can then be used to determine a subject matter of each of messages 160. In this way, using NLP techniques 242, controller 110 may, e.g., identify what kind of messages 160 different users 150 are receiving over a period to identify a baseline, and therein monitor subsequent messages 160 to ensure that they stay within a range of this baseline.

Memory 230 may further include machine learning techniques 244 that controller 110 may use to improve a process of managing communication as discussed herein over time. Machine learning techniques 244 can comprise algorithms or models that are generated by performing supervised, unsupervised, or semi-supervised training on a dataset, and subsequently applying the generated algorithm or model to manage communication to stay within baselines of baseline data 234.

Machine learning techniques 244 can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, machine learning techniques 244 can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAD), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning algorithms.

Using these components, controller 110 may manage communication by identifying baselines of communication for users and then taking remedial actions when communication is outside of a range from these baselines as discussed herein. For example, controller 110 may manage communication according to the flowchart depicted in FIG. 3. The flowchart of FIG. 3 is discussed with relation to FIGS. 1A and 1B for purposes of illustration, though it is to be understood that other systems and message may be used to execute the flowchart of FIG. 3 in other examples. Further, in some examples controller 110 may execute a different method than the flowchart of FIG. 3, or controller 110 may execute a similar method with more or less steps in a different order, or the like.

As depicted in FIG. 3, controller 110 may monitor communication of users (300). Controller 110 may monitor this communication as sent by a plurality of user devices 120 over network 140. Controller 110 may monitor this communication by functioning as a plugin on one or more communication applications, by tracking messages received by user devices 120, by tracking messages as moving across network 140, or by any other method consistent with this disclosure. Controller 110 may monitor communication for a predetermined set of users, such as users of an organization. Controller 110 may monitor the communication for a predetermined period of time that is sufficient to be reflective of standard communication across the organization. For example, controller 110 may monitor communication for three months.

Controller 110 may generate a model of the communication (302). This model may include substantially all messages sent by each of the plurality of users. The model may be organized (e.g., separated) by users, subject matter, clients, projects, or the like. In some examples, the model may be a chart, where each user, subject, and message are nodes, and these nodes are related by edges that indicate the relationships.

Controller 110 may establish baselines of communication for each of the users (304). Controller 110 may establish the baselines based on the model, wherein each of the respective baselines includes a respective range of probabilistic outcomes. As discussed herein, baselines may indicate a number of messages, a type of messages, one or more predetermined senders of these messages, or the like. Controller 110 may store these baselines and ranges on one or more databases 130.

Controller 110 may detect that communication is outside a range of a baseline for a user (306). Controller 110 may detect that this communication has been outside a range for a period of time, such as a week or a few weeks or a month. This period of time may be shorter than the first period over which controller 110 established baselines, but may still be long enough to be statistically significant.

In response to detecting this communication outside of the range of the baseline, controller 110 may execute simulations on the model (308). Controller 110 may execute simulations for a plurality of remedial actions. For example, controller 110 may simulate whether or not redirected detected messages may return communication back toward the baseline. Additionally, or alternatively, controller 110 may simulate whether or not generating brand new messages (e.g., based on detected subject matter across network 140) may return communication back toward the baseline.

In some examples, controller 110 may determine that relatively more substantial actions are necessary, such that users may need to change roles and/or receive new training. For example, controller 110 may use the generated model to identify that a new user was promoted into a role vacated by a previous user, and that since this promotion communication has not flowed well into an underutilized user. Controller 110 may run a plurality of simulations that all show that single messages may not be sufficient to fix this underutilization, given the communication habits of the new user. As such, controller 110 may analyze remedial actions that include changing the role of the new user, providing additional training to the new user, or the like.

Controller may execute a remedial action (310). Controller 110 may execute the remedial action that, according to the simulations, was likely to bring communication of the user within the range of the baseline for the user. For example, if controller 110 detected that the user was outside of a range for not receiving a threshold number of messages, controller 110 may execute one or more remedial actions that are configured to raise a number of received messages for user to a point where the user is above this threshold. In this way, controller 110 may be configured to manage communication of users across an organization as described herein.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-situation data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
monitoring communication between a plurality of users for a first period of time;
generating a model of the communication between the plurality of users for the first period of time;
establishing, based on the model, respective baselines of communication for each of the plurality of users, wherein each of the respective baselines includes a respective range of probabilistic outcomes;
detecting, over a second period of time, communication that is outside of a range of a baseline for a user of the plurality of users; and
executing a remedial action that is configured to bring communication of the user within the range of the baseline for the user.

2. The computer-implemented method of claim 1, further comprising:
simulating, using the model, a plurality of remedial actions that includes the remedial action; and
determining, via the simulations of the model, that the remedial action of the plurality of remedial actions is configured to bring communication of the user within the range of the baseline.

3. The computer-implemented method of claim 1, wherein the remedial action is executed automatically on a schedule, immediately, or on delay.

4. The computer-implemented method of claim 1, wherein the remedial action is provided to an identified user for the identified user to execute.

5. The computer-implemented method of claim 1, wherein the baseline of communication includes an average number of messages.

6. The computer-implemented method of claim 5, wherein:
the detecting that the communication is outside of the range includes detecting that the user is receiving less than a lower limit threshold of the range that is less than the average number of messages; and
the executing the remedial action includes redirecting some messages to the user.

7. The computer-implemented method of claim 5, wherein:
the detecting that the communication is outside of the range includes detecting that the user is receiving less than a lower limit of the range; and
the executing the remedial action includes generating some messages to send to the user.

8. The computer-implemented method of claim 1, wherein:
the model reflects a plurality of subjects;
the baseline of communication includes a number of messages related to a subject of the plurality of subjects;
the detecting that the communication is outside of the range includes detecting that the user is receiving less than a lower limit of the range for messages related to the subject; and
the executing the remedial action includes at least one of redirecting some messages related to the subject to the user or generating some messages related to the subject to send to the user.

9. The computer-implemented method of claim 1, wherein establishing respective baselines for the plurality of users includes identifying a role of each user of the plurality of users.

10. A system comprising:
a processor; and
a memory in communication with the processor, the memory containing instructions that, when executed by the processor, cause the processor to:
monitor communication between a plurality of users for a first period of time;
generate a model of the communication between the plurality of users for the first period of time;
establish, using the model, respective baselines of communication for each of the plurality of users, wherein each of the respective baselines includes a respective range of probabilistic outcomes;
detect, over a second period of time, communication that is outside of a range of a baseline for a user of the plurality of users; and
execute a remedial action that is configured to bring communication of the user within the range of the baseline for the user.

11. The system of claim 10, the memory further containing instructions that, when executed by the processor, cause the processor to:
simulate, using the model, a plurality of remedial actions that includes the remedial action; and
determine, via the simulations of the model, that the remedial action of the plurality of remedial actions is configured to bring communication of the user within the range of the baseline.

12. The system of claim 10, wherein the remedial action is executed automatically on a schedule, immediately, or on delay.

13. The system of claim 10, wherein the remedial action is provided to an identified user for the identified user to execute.

14. The system of claim 10, wherein:
the baseline of communication includes an average number of messages;
the detecting that the communication is outside of the range includes detecting that the user is receiving less than a lower limit threshold of the range that is less than the average number of messages; and
the executing the remedial action includes at least one of:
redirecting some messages to the user, or
generating some messages to send to the user.

15. The system of claim 10, wherein establishing respective baselines for the plurality of users includes identifying a role of each user of the plurality of users.

16. The system of claim 10, wherein:
the model reflects a plurality of subjects;
the baseline of communication includes a number of messages related to a subject of the plurality of subjects;
the detecting that the communication is outside of the range includes detecting that the user is receiving less than a lower limit of the range for messages related to the subject; and
the executing the remedial action includes at least one of:
redirecting some messages related to the subject to the user, or
generating some messages related to the subject to send to the user.

17. A computer program product, the computer program product comprising a computer readable storage medium having program instructions embodied therewith, the program instructions executable by a computer to cause the computer to:
monitor communication between a plurality of users for a first period of time;
generate a model of the communication between the plurality of users for the first period of time
establish, using the model, respective baselines of communication for each of the plurality of users, wherein each of the respective baselines includes a respective range of probabilistic outcomes;
detect, over a second period of time, communication that is outside of a range of a baseline for a user of the plurality of users; and
execute a remedial action that is configured to bring communication of the user within the range of the baseline for the user.

18. The computer program product of claim 17, the computer readable storage medium further having additional program instructions embodied that, when executed by the computer, cause the computer to:
simulate, using the model, a plurality of remedial actions that includes the remedial action; and
determine, via the simulations of the model, that the remedial action of the plurality of remedial actions is configured to bring communication of the user within the range of the baseline.

19. The computer program product of claim 17, wherein:
the baseline of communication includes a number of messages;
the detecting that the communication is outside of the range includes detecting that the user is receiving less than a lower limit of the range; and
the executing the remedial action includes at least one of:
redirecting some messages to the user, or
generating some message to send to the user.

20. The computer program product of claim 17, wherein the remedial action is executed autonomously.
